(19) United States
(12) Patent Application Publication
(10) Pub. No.: US 2025/0392637 A1
(43) Pub. Date: Dec. 25, 2025

(54) SYSTEMS AND METHODS FOR PRIORITIZING APPLICATION REQUESTS

(71) Applicant: Netflix, Inc., Los Gatos, CA (US)

(72) Inventors: Anirudh Mendiratta, Edmonds, WA (US); Shyam Bharat Gala, San Jose, CA (US); Benjamin Peter Fedorka, Mason, MI (US)

(21) Appl. No.: 18/752,423

(22) Filed: Jun. 24, 2024

(51) Int. Cl. H04L 67/1014; H04L 43/0864; H04L 47/2475

(52) U.S. Cl. CPC H04L 67/1014; H04L 43/0864; H04L 47/2475

(57) ABSTRACT

The disclosed computer-implemented method may include detecting, by a computing device of a server group, a set of in-flight requests for an application. The method may also include determining, by the computing device, that the set of in-flight requests exceeds a predetermined threshold for the server group. Additionally, the method may include identifying, by the computing device, a first type of request and a second type of request in the set of in-flight requests. Furthermore, the method may include prioritizing, by performing a load-shedding process for the server group, the first type of request over the second type of request. Finally, the method may include executing a remaining set of requests of the set of in-flight requests for the application. Various other methods, systems, and computer-readable media are also disclosed.

### BACKGROUND

Software applications often depend on servers or backend services to perform important functions. For example, users can run an application on personal devices that interface over a network with data or services hosted by a publisher of the application. The application can send requests to a server, which can then fulfill the requests to enable the application to perform various functions. When multiple users and devices are running the same application, a server or backend system may receive many requests at the same time, which can lead to throttling of network traffic. In some cases, servers may struggle to fulfill all of the requests, leading to application failures that can impact a user’s experience with the application.

Some systems attempt to separate different requests so that a flood of incoming non-critical requests does not reduce availability for critical requests. Some systems may use separate server groups to process critical requests and non-critical requests, thereby partitioning different requests through isolation. For example, for an application that plays videos, failure to execute a request generated by a user selecting a video can lead to playback failure. Meanwhile, client devices may preemptively perform prefetch requests in anticipation of video playback. By processing these prefetch requests on physically separate servers, some systems can prevent them from affecting the user-generated application requests. However, such systems can require a larger number of physically separate server groups, which may also require more overhead to configure each group. In these examples, the systems may also need more specific parameters to determine which requests are more important and to tailor server groups to specific applications. Thus, better methods of prioritizing application requests are needed to efficiently utilize server capacity while minimizing disruption to users.

### SUMMARY

As will be described in greater detail below, the present disclosure describes systems and methods for prioritizing in-flight application requests to maximize server usage. In one example, a computer-implemented method for prioritizing application requests may include detecting, by a computing device of a server group, a set of in-flight requests for an application. The method may also include determining, by the computing device, that the set of in-flight requests exceeds a predetermined threshold for the server group. In addition, the method may include identifying, by the computing device, a first type of request and a second type of request in the set of in-flight requests. Furthermore, the method may include prioritizing, by performing a load-shedding process for the server group, the first type of request over the second type of request. Finally, the method may include executing a remaining set of requests of the set of in-flight requests for the application.

In one embodiment, detecting the set of in-flight requests may include receiving network traffic from one or more client devices and detecting one or more requests for the application from the one or more client devices.

In one example, determining that the set of in-flight requests exceeds the predetermined threshold may include determining a total number of requests in the set of in-flight requests exceeds a threshold number of requests for the server group and/or determining a system latency exceeds a threshold latency for the server group. In this example, the system latency may include a latency of one or more requests in the set of in-flight requests and/or a latency in a downstream service of the server group.

In some embodiments, the first type of request may include a user-initiated request categorized by an application programming interface of the application. Similarly, in some embodiments, the second type of request may include a prefetch request initiated by a client device for the application.

In one embodiment, prioritizing the first type of request over the second type of request may include executing all requests of the first type of request prior to executing any request of the second type of request and dropping a request of the second type of request based on a timing of the request. Additionally or alternatively, prioritizing the first type of request over the second type of request may include dynamically repurposing a reserved capacity of the server group for the first type of request.

In some examples, the computer-implemented method may further include isolating a request of the set of in-flight requests based on a type of the request.

In some embodiments, the computer-implemented method may further include updating the set of in-flight requests for the application, determining that the updated set of in-flight requests does not exceed the predetermined threshold for the server group, and executing the updated set of in-flight requests. In these embodiments, executing the updated set of in-flight requests may include suspending the load-shedding process for the server group.

In addition, a corresponding system for prioritizing application requests may include several modules stored in memory, including a detection module that detects, by a computing device of a server group, a set of in-flight requests for an application. The system may also include a determination module that determines, by the computing device, that the set of in-flight requests exceeds a predetermined threshold for the server group. In addition, the system may include an identification module that identifies, by the computing device, a first type of request and a second type of request in the set of in-flight requests. Furthermore, the system may include a prioritization module that prioritizes, by performing a load-shedding process for the server group, the first type of request over the second type of request. Additionally, the system may include an execution module that executes a remaining set of requests of the set of in-flight requests for the application. Finally, the system may include one or more processors that execute the detection module, the determination module, the identification module, the prioritization module, and the execution module.

In one embodiment, the server group may include a distributed system with a set of servers that services application requests for a set of client devices. In this embodiment, the determination module may determine that the set of in-flight requests exceeds the predetermined threshold for the server group by detecting a total current capacity of the set of servers and determining that an expected capacity to execute the set of in-flight requests exceeds the total current capacity of the set of servers. Additionally, in this embodiment, the detection module may detect the set of in-flight requests for the application by receiving, at an application programming interface of the server group, one or more application requests from an application programming interface of a client device in the set of client devices.

In one example, the prioritization module may include a concurrency limiter that determines a concurrency limit for executing application requests by the application programming interface of the server group. In this example, the prioritization module may prioritize the first type of request over the second type of request in response to the application programming interface of the server group reaching the concurrency limit.

In some embodiments, the load-shedding process may include a process to select one or more requests of the second type of request and drop the one or more requests.

In one embodiment, the identification module may further identify a third type of request and a fourth type of request in the set of in-flight requests, and the prioritization module may further prioritize, by performing the load-shedding process for the server group, the third type of request over the fourth type of request.

In some examples, the above-described method may be encoded as computer-readable instructions on a computer-readable medium. For example, a computer-readable medium may include one or more computer-executable instructions that, when executed by at least one processor of a computing device, may cause the computing device to detect, by the computing device of a server group, a set of in-flight requests for an application. The instructions may also cause the computing device to determine, by the computing device, that the set of in-flight requests exceeds a predetermined threshold for the server group. In addition, the instructions may cause the computing device to identify, by the computing device, a first type of request and a second type of request in the set of in-flight requests. Furthermore, the instructions may cause the computing device to prioritize, by performing a load-shedding process for the server group, the first type of request over the second type of request. Finally, the instructions may cause the computing device to execute a remaining set of requests of the set of in-flight requests for the application.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a flow diagram of an exemplary method for prioritizing application requests.

FIG. 2 is a block diagram of an exemplary computing system for prioritizing application requests.

FIG. 3 is a block diagram of an exemplary server group that services an exemplary set of client devices.

FIG. 4 is a block diagram of an exemplary downstream service that impacts a latency of an exemplary server group.

FIG. 5 is a block diagram of exemplary allocation of requests to exemplary servers.

FIG. 6 is a block diagram of an exemplary repurposing of a capacity of an exemplary server group.

FIG. 7 is a block diagram of an exemplary fulfillment of requests without exemplary load-shedding.

FIG. 8 is a block diagram of an exemplary content distribution ecosystem.

FIG. 9 is a block diagram of an exemplary distribution infrastructure within the content distribution ecosystem shown in FIG. 8.

FIG. 10 is a block diagram of an exemplary content player within the content distribution ecosystem shown in FIG. 8.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to prioritizing application requests in a server group. As will be explained in greater detail below, embodiments of the present disclosure may, by providing an application-level load-shedding mechanism, preserve server availability and maintain an uninterrupted application experience during periods of throttling. The disclosed systems and methods may first categorize application requests by priority. For example, the disclosed systems and methods may categorize a manifest request generated by a user selecting a play option as a user-initiated request. By identifying user-initiated requests and prefetch requests, the systems and methods described herein may determine user-initiated requests are more critical to user experience in real time than prefetch requests made to preemptively request data or resources. In some examples, the disclosed systems and methods may determine in-flight requests exceed a capacity that a server group can handle. For example, the systems and methods described herein may determine the number of requests that are in progress is greater than a capacity for the server group to execute in a timely manner. As another example, the systems and methods described herein may detect a latency in fulfilling requests that is greater than an acceptable latency. In addition, by detecting latencies in downstream services, the disclosed systems and methods may use contextual information about local systems to prioritize certain requests and improve throughput for the global system.

The disclosed systems and methods may then perform load-shedding to drop requests of lower priority. For example, the systems and methods described herein may drop prefetch requests that are not immediately critical to reduce the failure rate of critical requests. Furthermore, the disclosed systems and methods may dynamically repurpose server capacity to fulfill priority requests. For example, by using a single server group rather than multiple separate groups, the disclosed systems and methods may reduce overhead capacity that may be made available for the most critical functions and requests. The disclosed systems and methods may then execute the in-flight requests that are not dropped during load-shedding.

The systems and methods described herein may improve the functioning of a computing device by combining servers into a single server group to reduce operational overhead costs and execute application requests without separate server groups for different types of requests. In addition, these systems and methods may also improve the fields of software architecture and application traffic management by isolating application traffic of different categories and dropping lower priority requests when the system is saturated to ensure critical requests are executed. Thus, the disclosed systems and methods may improve over traditional methods of prioritizing application requests that are less efficient and require physical partitions.

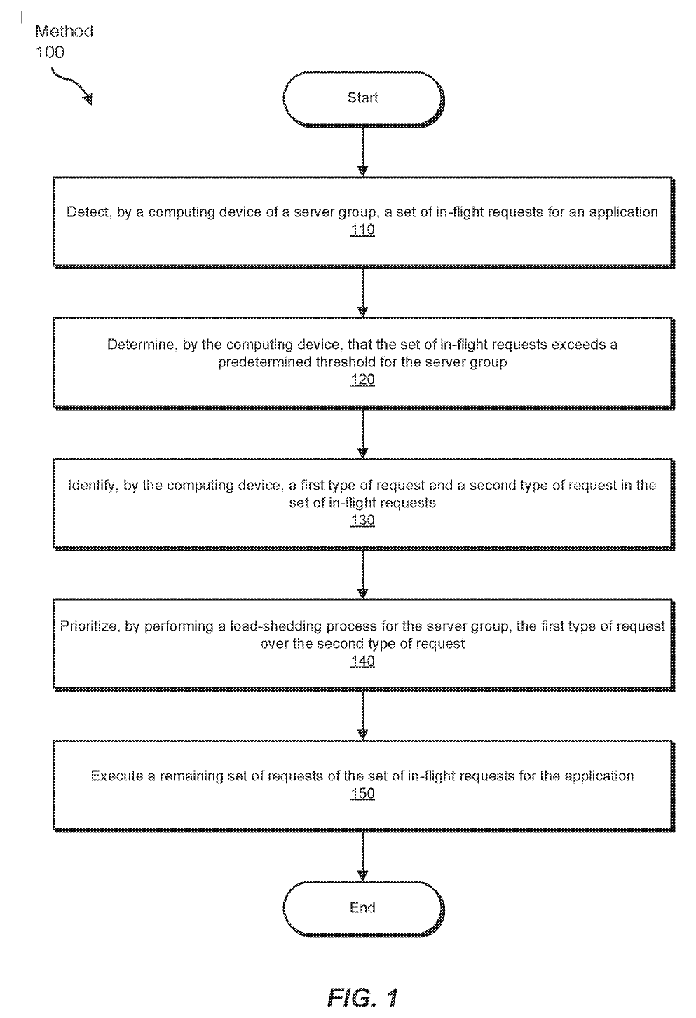

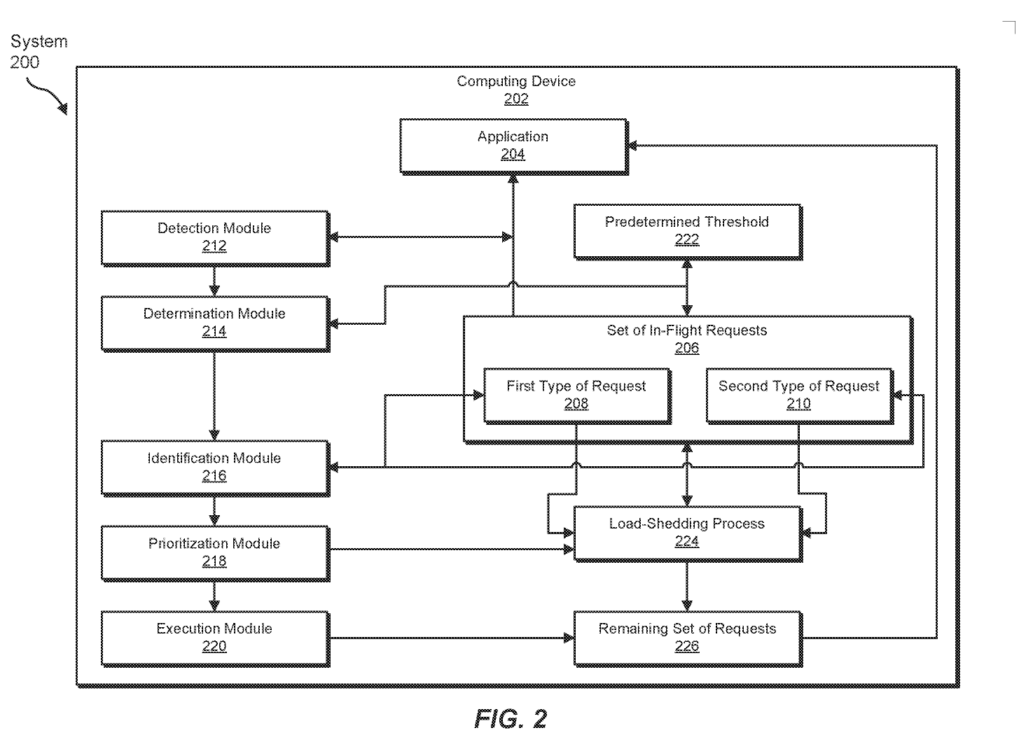

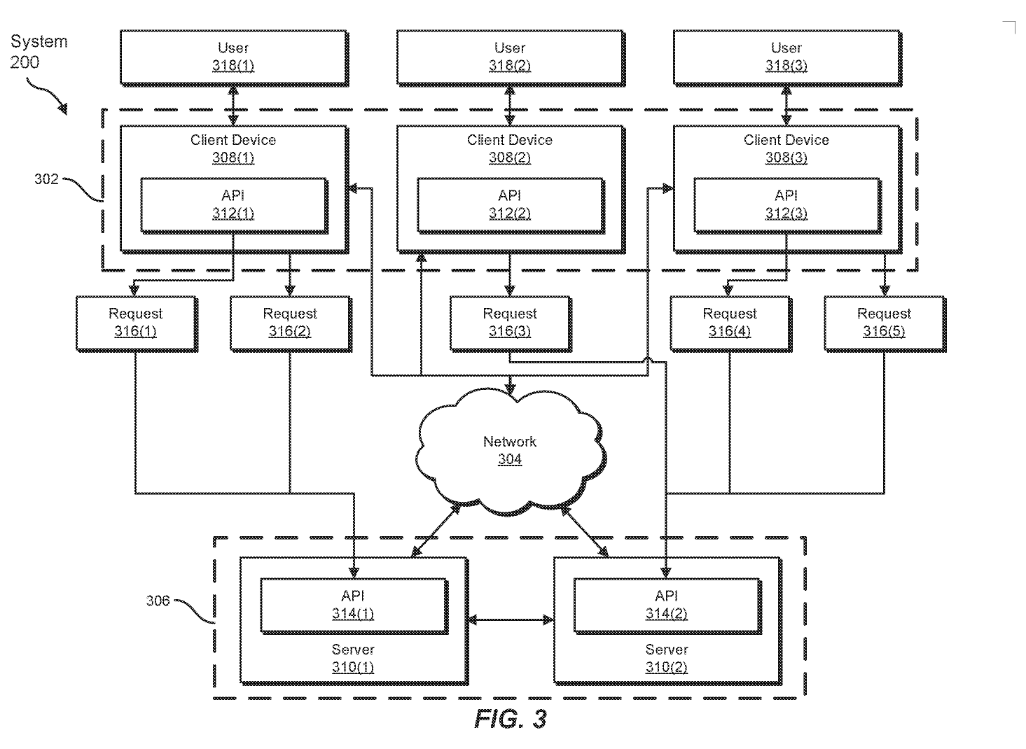

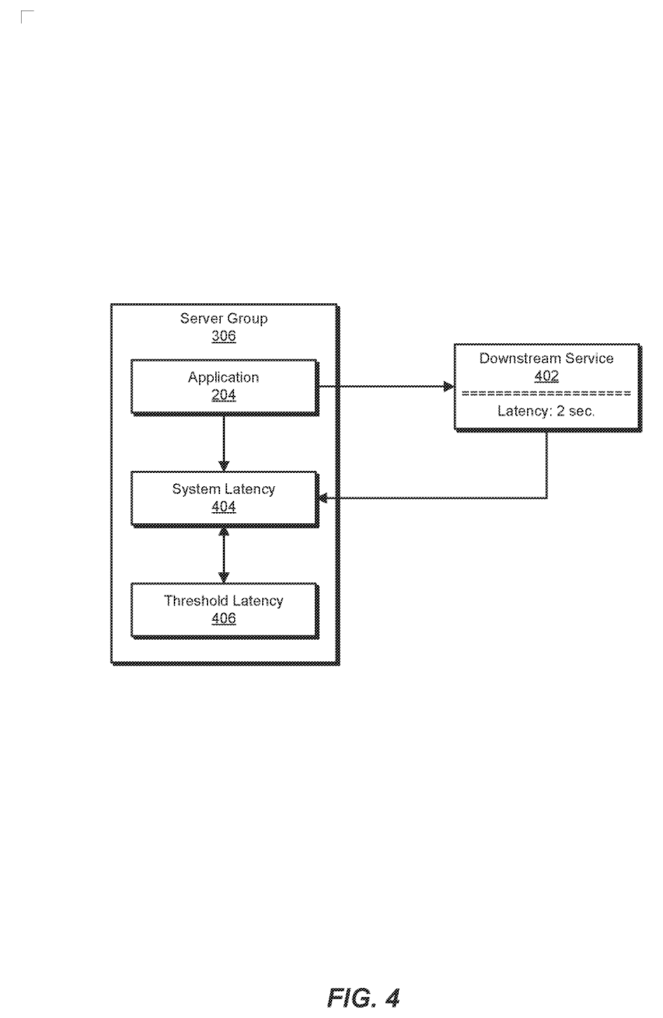

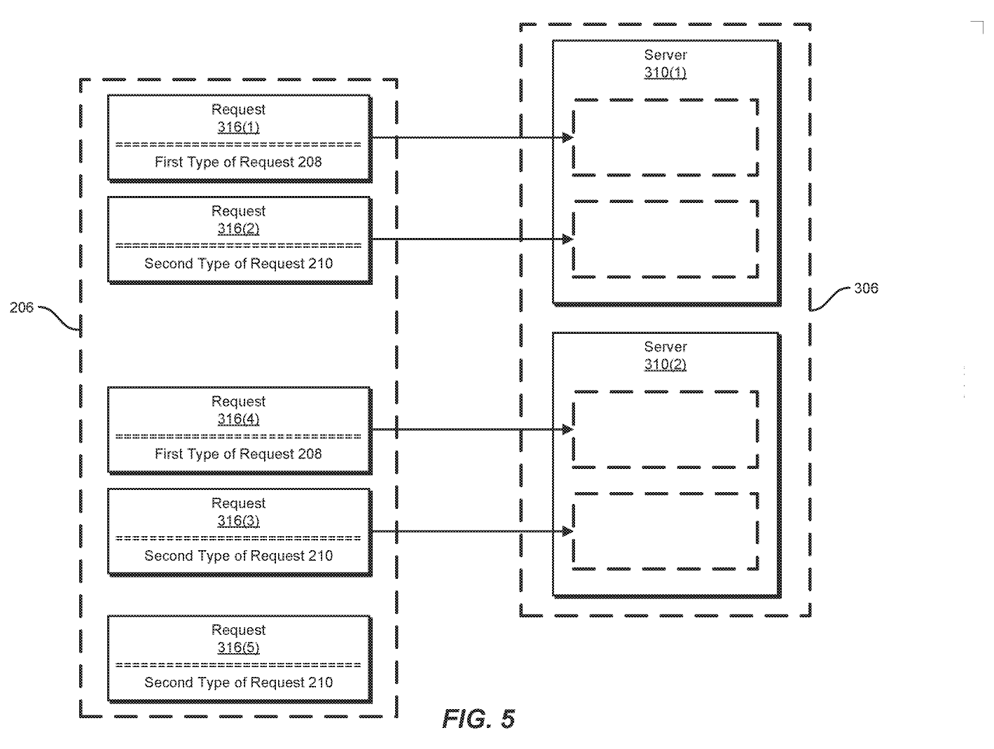

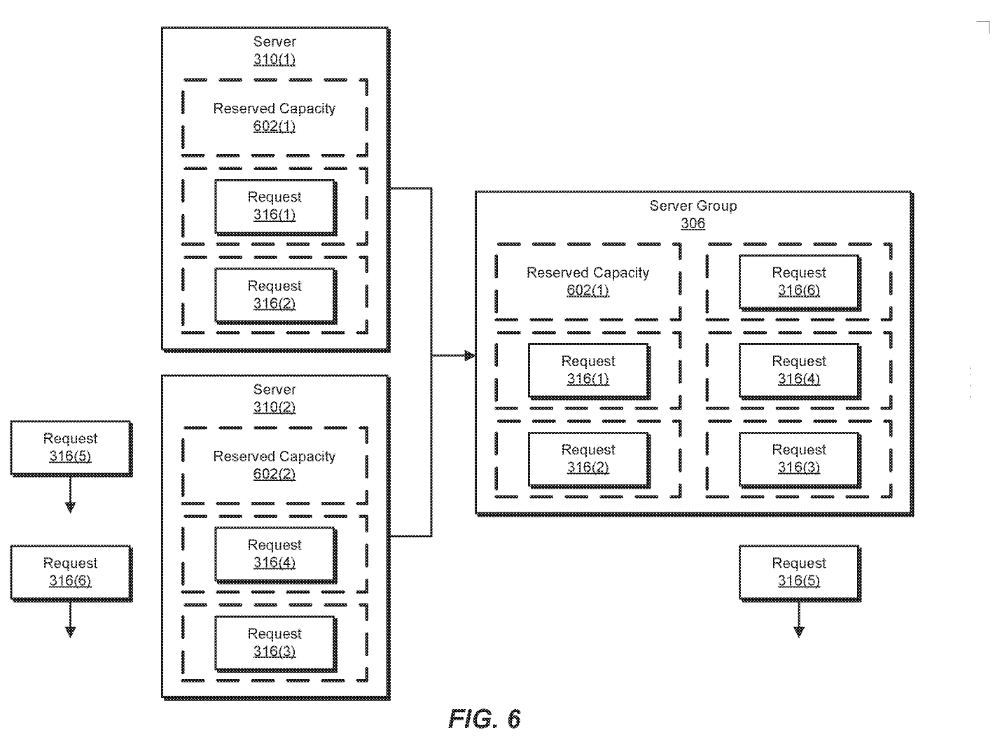

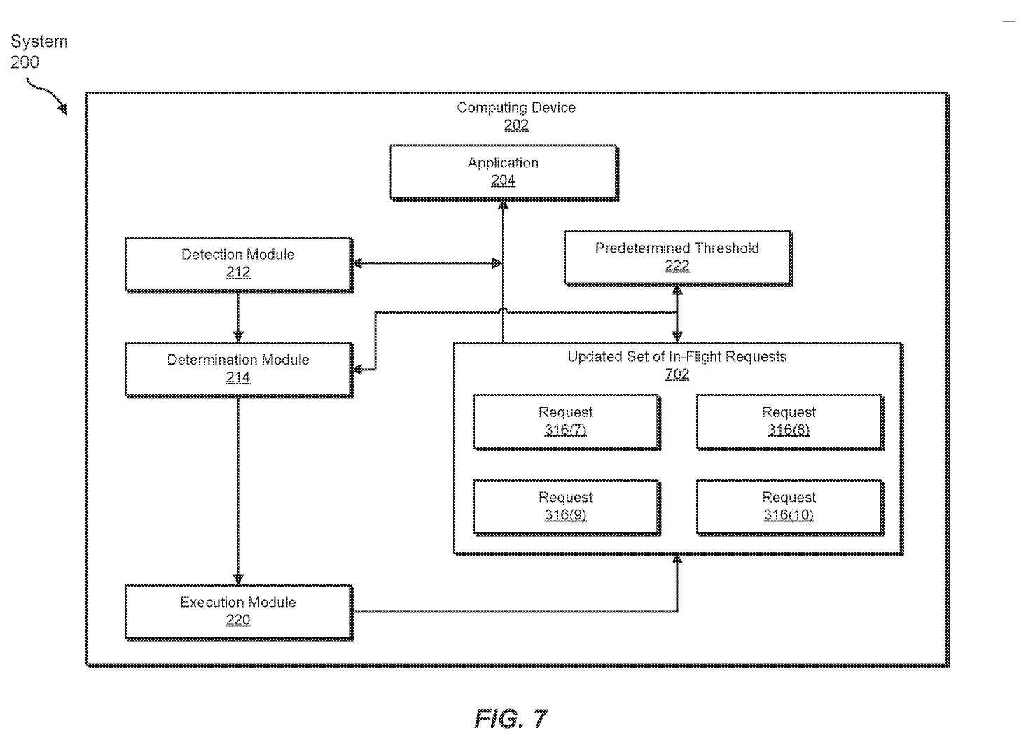

Thereafter, the description will provide, with reference to FIG. 1, detailed descriptions of computer-implemented methods for prioritizing application requests. Detailed descriptions of a corresponding exemplary computing system will be provided in connection with FIG. 2. Detailed descriptions of an exemplary server group that services an exemplary set of client devices will be provided in connection with FIG. 3. In addition, detailed descriptions of an exemplary downstream service that impacts a latency of an exemplary server group will be provided in connection with FIG. 4. Detailed descriptions of exemplary allocation of requests to exemplary servers will be provided in connection with FIG. 5. Furthermore, detailed descriptions of an exemplary repurposing of a capacity of an exemplary server group will be provided in connection with FIG. 6. Additionally, detailed descriptions of an exemplary fulfillment of requests without load-shedding will be provided in connection with FIG. 7.

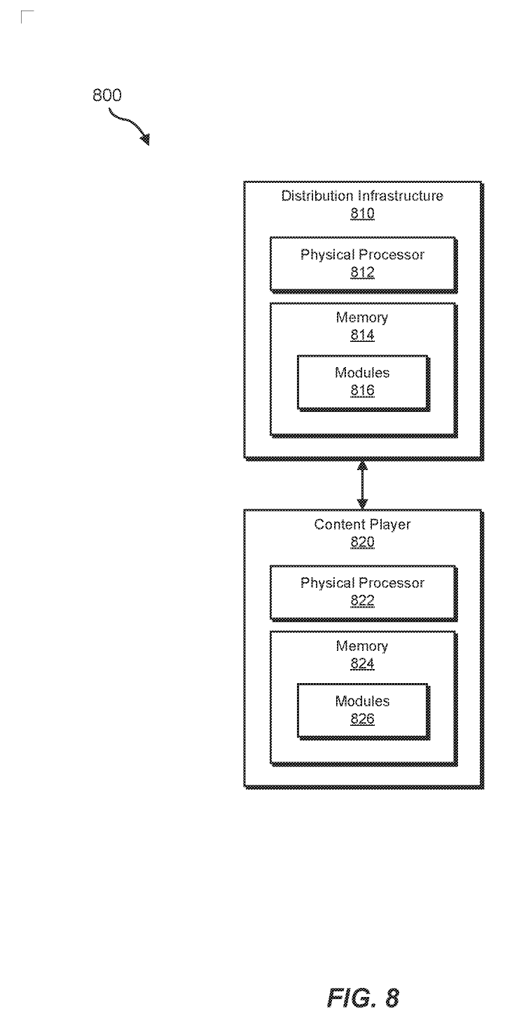

Because many of the embodiments described herein may be used with substantially any type of computing network, including distributed networks designed to provide video content to a worldwide audience, various computer network and video distribution systems will initially be described with reference to FIGS. 8-10. These figures will introduce the various networks and distribution methods used to provision video content to users.

FIG. 1 is a flow diagram of an exemplary computer-implemented method 100 for prioritizing application requests. The steps shown in FIG. 1 may be performed by any suitable computer-executable code and/or computing system, including the systems illustrated in FIGS. 8-10, computing device 202 in FIG. 2, servers 310(1)-(2) and/or server group 306 of FIG. 3, or a combination of one or more of the same. In one example, each of the steps shown in FIG. 1 may represent an algorithm whose structure includes and/or is represented by multiple sub-steps, examples of which will be provided in greater detail below. In some examples, all of the steps and sub-steps represented in FIG. 1 may be performed by one device (e.g., either a server or a client computing device). Alternatively, the steps and/or substeps represented in FIG. 1 may be performed across multiples devices (e.g., some of steps and/or sub-steps may be performed by a server and other steps and/or sub-steps may be performed by a client computing device).

As illustrated in FIG. 1, at step 110, one or more of the systems described herein may detect, by a computing device of a server group, a set of in-flight requests for an application. For example, FIG. 2 is a block diagram of an exemplary system 200 for prioritizing application requests. As illustrated in FIG. 2, a detection module 212 may, as part of a computing device 202, detect a set of in-flight requests 206 for an application 204.

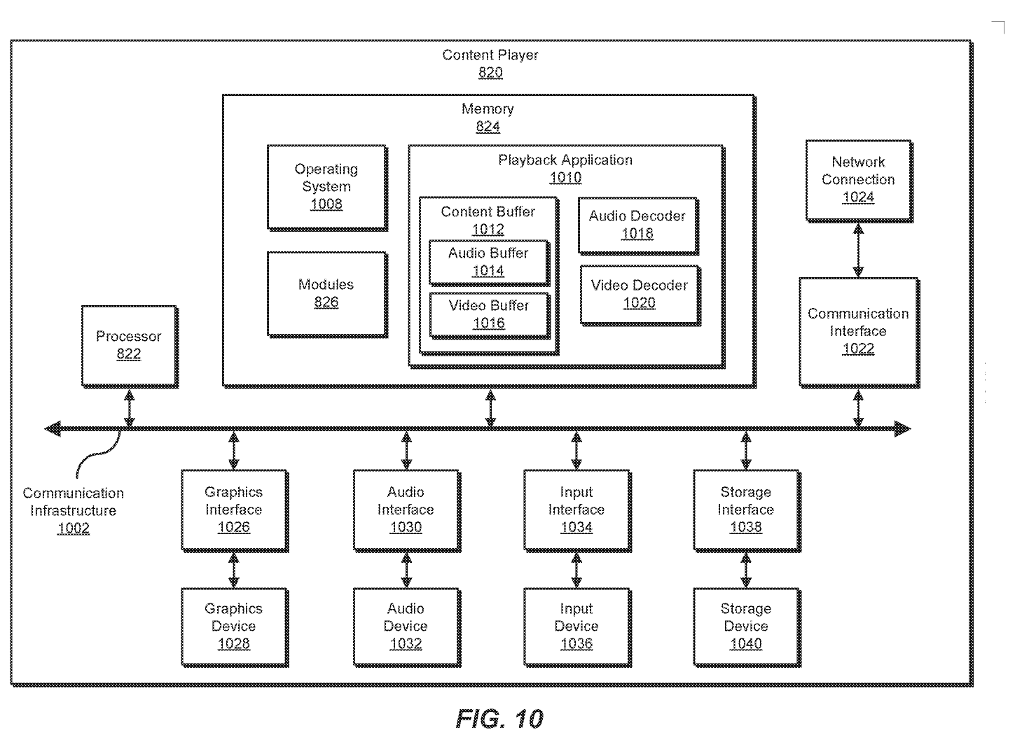

In some embodiments, computing device 202 may generally represent any type or form of computing device capable of running computing software and applications. As used herein, the term “application” generally refers to a software program designed to perform specific functions or tasks and capable of being installed, deployed, executed, and/or otherwise implemented on a computing system. Examples of applications may include, without limitation, playback application 1010 of FIG. 10, productivity software, enterprise software, entertainment software, security applications, cloud-based applications, web applications, mobile applications, content access software, simulation software, integrated software, application packages, application suites, variations or combinations of one or more of the same, and/or any other suitable software application.

Computing device 202 may alternatively generally represent any type or form of server that is capable of storing and/or managing data, such as storing and/or processing videos and processing set of in-flight requests 206 from client devices. Examples of a server include, without limitation, application servers and database servers configured to provide various database services and/or run certain software applications, such as communication and data transmission services. Additionally, computing device 202 may include distribution infrastructure 810, and/or various other components of FIGS. 8-10.

Although illustrated as part of computing device 202 in FIG. 2, some or all of the modules described herein may alternatively be executed by a separate server or any other suitable computing device. For example, computing device 202 may represent a separate device for managing a server group and may preprocess in-flight requests before passing them to servers to execute.

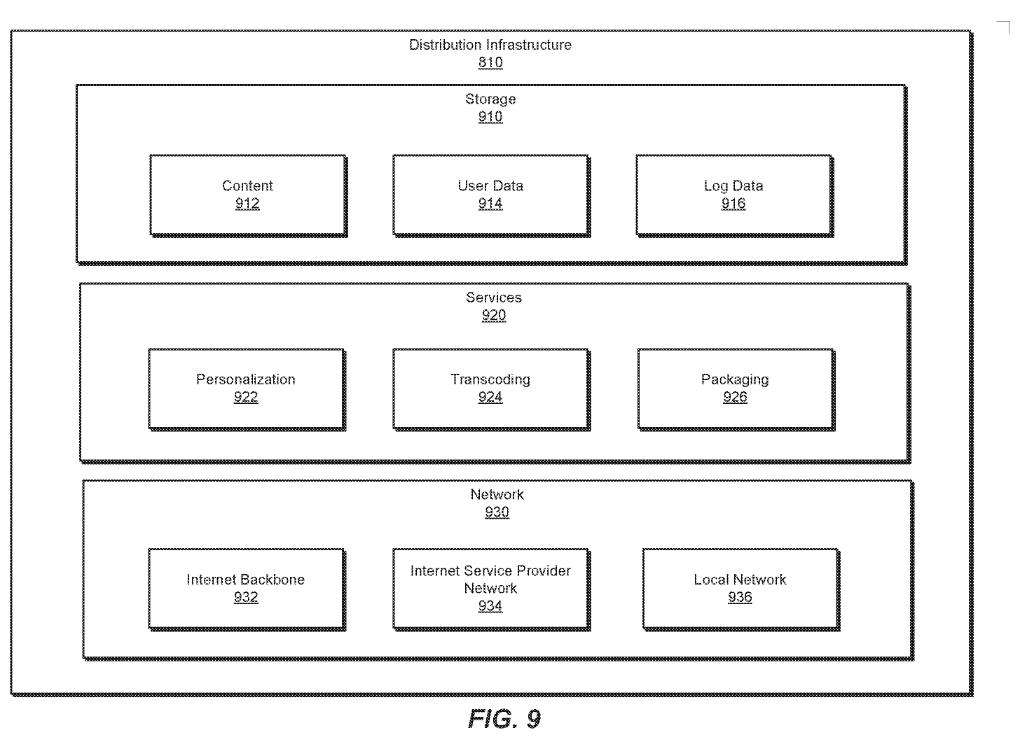

In the above embodiments, computing device 202 may be directly in communication with other servers and/or in communication with other computing devices, such as client devices 308(1)-(3) of FIG. 3, via a network, such as network 304 of FIG. 3. In some examples, the term “network” may refer to any medium or architecture capable of facilitating communication or data transfer. Examples of networks include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), network 930 of FIG. 9, or any other suitable network. For example, the network may facilitate data transfer between computing device 202 and client devices using wireless or wired connections and between computing device 202 and other servers of the same server group.

The systems described herein may perform step 110 in a variety of ways. The terms “request” and “application request,” as used herein, generally refer to communication from a client to a server, particularly to send or receive data or to perform a function for an application. The term “in-flight request” generally refers to a request that has been initiated but not fulfilled, such as a request that is sent by a client device but has not yet received a response from a server.

In some embodiments, detection module 212 may detect set of in-flight requests 206 by receiving network traffic from one or more client devices and detecting at least one request for application 204 from the network traffic. As used herein, the term “network traffic” generally refers to any data transmitted through a network.

In some examples, computing device 202 may represent a device or server that is part of a server group. In these examples, the server group may include a distributed system with a set of servers that services application requests for a set of client devices. In these examples, a client device may initiate a single instance of communication with the server group, and the server group may allocate application requests to servers in the server group for in-flight requests from any client of the set of client devices. Examples of client devices, such as client devices 308(1)-(3) of FIG. 3, may include, without limitation, laptops, tablets, desktops, servers, cellular phones, Personal Digital Assistants (PDAs), multimedia players, embedded systems, wearable devices (e.g., smart watches, smart glasses, etc.), gaming consoles, combinations of one or more of the same, or any other suitable computing device. Additionally, client devices may include content player 820 in FIGS. 8 and 10, distribution infrastructure 810, and/or various other components of FIGS. 8-10.

In one embodiment, detection module 212 may detect set of in-flight requests 206 for application 204 by receiving, at an application programming interface (API) of the server group, one or more application requests from an application programming interface (API) of a client device in the set of client devices. The term “application programming interface,” as used herein, generally refers to a software component that enables communication between an application and other applications or software components. For example, an API of the server group may communicate with other applications on a server and/or client devices, and an API of a client device may communicate with other applications on the client device and/or the server group.

As illustrated in FIG. 3, a set of client devices 302 may include client devices 308(1)-(3) and may be in communication with a server group 306 that includes servers 310(1)-(2). In this example, set of client devices 302 and server group 306 may communicate over network 304. Additionally, client devices 308(1)-(3) may each include APIs 312(1)-(3), respectively, and servers 310(1)-(2) may include APIs 314(1)-(2), respectively. In this example, client devices 308(1)-(3) may be used by users 318(1)-(3), respectively.

Returning to FIG. 1, at step 120, one or more of the systems described herein may determine, by the computing device, that the set of in-flight requests exceeds a predetermined threshold for the server group. For example, a determination module 214 may, as part of computing device 202 in FIG. 2, determine that set of in-flight requests 206 exceeds a predetermined threshold 222 for the server group.

The systems described herein may perform step 120 in a variety of ways. In some examples, determination module 214 may determine that set of in-flight requests 206 exceeds predetermined threshold 222 by determining a total number of requests in set of in-flight requests 206 exceeds a threshold number of requests for server group 306. Additionally or alternatively, determination module 214 may determine a system latency exceeds a threshold latency for server group 306. As used herein, the term “latency” generally refers to a delay or a measure of time taken to transmit or process data. For example, when the total number of requests in set of in-flight requests 206 exceeds the threshold number of requests that server group 306 can simultaneously handle, additional requests may slow down all requests, including current requests.

In the above examples, the system latency may include a latency of one or more requests in set of in-flight requests 206. For example, determination module 214 may determine that an application request has a delay in fulfillment. Additionally or alternatively, the system latency may include a latency in a downstream service of server group 306. The term “downstream service,” as used herein, generally refers to a service or software to which data is sent. In these examples, server group 306 may send data or requests to the downstream service for additional processing. In some examples, determination module 214 may determine a latency in receiving data, processing data, and/or sending data from server group 306.

As illustrated in FIG. 4, server group 306 may include application 204 that sends data, such as an application request, to a downstream service 402. In this example, downstream service 402 may perform additional functions that may result in a latency of 2 seconds. In this example, a system latency 404 of server group 306 may be impacted by the latency of downstream service 402. In this example, determination module 214 may then determine that system latency 404 exceeds a threshold latency 406.

In some embodiments, determination module 214 may determine that set of in-flight requests 206 exceeds predetermined threshold 222 by detecting a total current capacity of the set of servers and determining that an expected capacity to execute set of in-flight requests 206 exceeds the total current capacity of the set of servers. In these embodiments, the capacity of the set of servers may include a memory capacity and/or a processing capacity of server group 306. As illustrated in FIG. 5, server 310(1) and server 310(2) may have a capacity to simultaneously process two requests each. In this example, set of in-flight requests 206 may include requests 316(1)-(5), which may include one request more than the total current capacity of server group 306.

Returning to FIG. 1, at step 130, one or more of the systems described herein may identify, by the computing device, a first type of request and a second type of request in the set of in-flight requests. For example, an identification module 216 may, as part of computing device 202 in FIG. 2, identify a first type of request 208 and a second type of request 210 in set of in-flight requests 206.

The systems described herein may perform step 130 in a variety of ways. In one embodiment, first type of request 208 may include a user-initiated request categorized by an application programming interface of the application. In some embodiments, second type of request 210 may include a prefetch request initiated by a client device for application 204. The term “prefetch request,” as used herein, may refer to a preemptive request to retrieve data or resources based on predicting future usage. For example, as illustrated in FIG. 3, request 316(1) may be a request initiated by user 318(1) of client device 308(1), and request 316(4) may be initiated by user 318(3) of client device 308(3). In contrast, requests 316(2), 316(3), and 316(5) may represent prefetch requests initiated by client devices 308(1)-(3), respectively, in anticipation of potential actions by users 318(1)-(3), respectively. In these examples, prefetch requests may request data or resources that are not yet needed by application 204. For example, a user-initiated request may include a playback request, a manifest request, a license request triggered by the user pressing play, and/or any other suitable request for data or services triggered by a user action, and a prefetch request may include a playback request, a manifest request, a license request made by the client device, and/or other requests in anticipation of usage without direct user action.

Returning to FIG. 1, at step 140, one or more of the systems described herein may prioritize, by performing a load-shedding process for the server group, the first type of request over the second type of request. For example, a prioritization module 218 may, as part of computing device 202 in FIG. 2, prioritize, by performing a load-shedding process 224, first type of request 208 over second type of request 210.

The systems described herein may perform step 140 in a variety of ways. The term “load-shedding,” as used herein, generally refers to a method of intentionally reducing a load on a system, such as by dropping network traffic. For example, a user-initiated request may indicate a user selecting an option to play a video in a video playback application, while a prefetch request may indicate a client device prediction that a user may play a video while the user is browsing a list of videos. In this example, prefetch requests may be optimistic predictions of user activity that enables client devices to reduce delay in performing future functions. In this example, prioritization module 218 may prioritize user-initiated requests while performing load-shedding on prefetch requests that may not immediately translate to playback failure.

In some examples, prioritization module 218 may prioritize first type of request 208 over second type of request 210 by executing all requests of first type of request 208 prior to executing any request of second type of request 210. In these examples, prioritization module 218 may then drop one or more requests of second type of request 210 based on a timing of the requests. In these examples, load-shedding process 224 may include a process to select one or more requests of second type of request 210 and to drop the one or more requests.

In some embodiments, prioritization module 218 may include a concurrency limiter that determines a concurrency limit for executing application requests by an application programming interface of server group 306. In these embodiments, prioritization module 218 may prioritize first type of request 208 over second type of request 210 in response to the application programming interface of server group 306 reaching the concurrency limit. The term “concurrency,” as used herein, generally refers to an ability to simultaneously or concurrently perform multiple processes. In other words, the concurrency limit may refer to a limit in a number of functions or requests that server group 306 may simultaneously process.

In the example of FIG. 5, prioritization module 218 may prioritize request 316(1) and request 316(4) of first type of request 208. In this example, prioritization module 218 may distribute request 316(1) to be processed by server 310(1) and request 316(4) to be processed by server 310(2). In this example, with additional capacity remaining, prioritization module 218 may then identify lower priority requests 316(2)-(3) and also distribute the requests to servers 310(1)-(2), respectively. In this example, with no excess capacity remaining, prioritization module 218 may then drop request 316(5) of lower priority second type of request 210. In another example, if user 318(3) is actively using application 204 on client device 308(3), prioritization module 218 may instead prioritize request 316(5) over request 316(3). By prioritizing different types of requests, prioritization module 218 may effectively create a partition for user-initiated requests that ensure throughput of these requests while only processing prefetch requests based on excess capacity.

In one embodiment, prioritization module 218 may prioritize first type of request 208 over second type of request 210 by dynamically repurposing a reserved capacity of server group 306 for first type of request 208. In this embodiment, prioritization module 218 may dynamically and automatically react to a current status of system 200 to reallocate server capacity. For example, for a live streaming event that uses high traffic for video playback, server capacity for non-critical requests can be leveraged to handle the traffic spike. In this embodiment, rather than using multiple server groups with operational overhead to ensure the right configurations for each server group and to deploy the same code to each server group, the disclosed systems and methods may reserve a capacity for operational overhead of a single server group.

As illustrated in FIG. 6, separated servers 310(1) and 310(2) may require a reserved capacity 602(1) for server 310(1) and a reserved capacity 602(2) for server 310(2). In this example, requests 316(5) and 316(6) may be dropped due to limited capacity. In contrast, by combining servers 310(1)-(2) into server group 306, only reserved capacity 602(1) may be required for operational overhead. In this example, request 316(6), which may be of first type of request 208, may then be processed using the capacity previously reserved as reserved capacity 602(2). Although illustrated as combining multiple servers into server group 306, FIG. 6 may instead represent combining multiple server groups into a single server group.

Returning to FIG. 1, at step 150, one or more of the systems described herein may execute a remaining set of requests of the set of in-flight requests for the application. For example, an execution module 220 may, as part of computing device 202 in FIG. 2, execute a remaining set of requests 226 of set of in-flight requests 206 for application 204.

The systems described herein may perform step 150 in a variety of ways. In some examples, remaining set of requests 226 may represent all requests of set of in-flight requests 206 that have not been dropped during load-shedding process 224. In some examples, execution module 220 may then execute remaining set of requests 226 by prioritizing execution of first type of request 208. In these examples, execution module 220 may then execute requests of second type of request 210 based on a timing of when each request was received, such as by maintaining a queue, by referencing prioritization module 218, and/or by any other method to determine priority of remaining set of requests 226.

In some embodiments, the above described systems may further include isolating a request of set of in-flight requests 206 based on a type of the request. For example, prioritization module 218 may effectively isolate requests of first type of request 208 from requests of second type of request 210 by processing requests of first type of request 208 first. In some examples, system 200 may isolate requests of second type of request 210 that are dropped to identify potential points of failure for application 204.

In some embodiment, the above described methods may further include updating set of in-flight requests 206 for application 204, determining that the updated set of in-flight requests does not exceed predetermined threshold 222 for server group 306, and executing the updated set of in-flight requests. In these embodiments, executing the updated set of in-flight requests may include suspending load-shedding process 224. For example, as illustrated in FIG. 7, detection module 212 may detect an updated set of in-flight requests 702, which may include new requests 316(7)-(10). In this example, determination module 214 may then determine that updated set of in-flight requests 702 does not exceed predetermined threshold 222. In this example, rather than performing load-shedding process 224, computing device 202 may directly proceed to execution module 220 executing updated set of in-flight requests 702. In other words, when there is no throttling of system 200, all requests may be served.

In some examples, identification module 216 may further identify a third type of request and a fourth type of request in set of in-flight requests 206. In these examples, prioritization module 218 may further prioritize, by performing load-shedding process 224, the third type of request over the fourth type of request. In these examples, the third type of request and the fourth type of request may represent additional categories for partitioning and prioritizing application requests. For example, prioritization module 218 may further prioritize requests from one type of client device over another type of client device. In other examples, system 200 may partition or prioritize application requests in any dimension or at various levels of processing requests. For example, systems with microservices may perform prioritization and/or load-shedding separately for isolated services, which may not have contextual information about downstream services. The disclosed systems and methods may enable consideration of both the global system and local systems to apply prioritization for different applications and services.

In additional examples, the disclosed systems and methods may actively implement prioritization prior to receiving set of in-flight requests 206 by using predetermined weights to process different types of requests. For example, with a scheduled livestreaming event, system 200 may predict a likelihood of excess network traffic that may cause throttling, and computing device 202 may prepare to perform load-shedding process 224 as requests are received.

As explained above in connection with method 100 in FIG. 1, the disclosed systems and methods may, by performing load-shedding using a single server group or cluster, improve the efficiency of processing application requests with limited server capacity. Specifically, the disclosed systems and methods may first divide requests into critical and non-critical requests, such as user-initiated versus device-initiated requests. Critical requests may then be prioritized for execution over non-critical requests. By sorting different types of requests and performing load-shedding on only non-critical requests, the systems and methods described herein may effectively implement failure isolation between types of requests without actually separating requests into different physical servers. Additionally, by implementing a single server group, the systems and methods described herein may simplify partitioning and reduce the capacity needed for operational overhead of the server group.

The disclosed systems and methods may then perform load-shedding to drop non-critical requests in order to ensure critical requests are able to be executed. For example, the systems and methods described herein may drop prefetch requests that do not actively impact application use. In other words, by separating network traffic into different buckets, the disclosed systems and methods may isolate user-initiated or active requests from prefetch requests. This may also enable the disclosed systems and methods to dynamically repurpose server capacity to prioritize the most critical functions first. Additionally, the systems and methods described herein may perform load-shedding to prioritize different types of requests for different applications or services, which may be combined such that the overall system is optimized. Thus, the systems and methods described herein may more efficiently and effectively utilize server capacity to prioritize application requests.

Content that is created or modified using the methods described herein may be used and/or distributed in a variety of ways and/or by a variety of systems. Such systems may include content distribution ecosystems, as shown in FIGS. 8-10.

FIG. 8 is a block diagram of a content distribution ecosystem 800 that includes a distribution infrastructure 810 in communication with a content player 820. In some embodiments, distribution infrastructure 810 may be configured to encode data and to transfer the encoded data to content player 820 via data packets. Content player 820 may be configured to receive the encoded data via distribution infrastructure 810 and to decode the data for playback to a user. The data provided by distribution infrastructure 810 may include audio, video, text, images, animations, interactive content, haptic data, virtual or augmented reality data, location data, gaming data, or any other type of data that may be provided via streaming.

Distribution infrastructure 810 generally represents any services, hardware, software, or other infrastructure components configured to deliver content to end users. For example, distribution infrastructure 810 may include content aggregation systems, media transcoding and packaging services, network components (e.g., network adapters), and/or a variety of other types of hardware and software. Distribution infrastructure 810 may be implemented as a highly complex distribution system, a single media server or device, or anything in between. In some examples, regardless of size or complexity, distribution infrastructure 810 may include at least one physical processor 812 and at least one memory device 814. One or more modules 816 may be stored or loaded into memory 814 to enable adaptive streaming, as discussed herein.

Content player 820 generally represents any type or form of device or system capable of playing audio and/or video content that has been provided over distribution infrastructure 810. Examples of content player 820 include, without limitation, mobile phones, tablets, laptop computers, desktop computers, televisions, set-top boxes, digital media players, virtual reality headsets, augmented reality glasses, and/or any other type or form of device capable of rendering digital content. As with distribution infrastructure 810, content player 820 may include a physical processor 822, memory 824, and one or more modules 826. Some or all of the adaptive streaming processes described herein may be performed or enabled by modules 826, and in some examples, modules 816 of distribution infrastructure 810 may coordinate with modules 826 of content player 820 to provide adaptive streaming of multimedia content.

In certain embodiments, one or more of modules 816 and/or 826 in FIG. 8 may represent one or more software applications or programs that, when executed by a computing device, may cause the computing device to perform one or more tasks. For example, and as will be described in greater detail below, one or more of modules 816 and 826 may represent modules stored and configured to run on one or more general-purpose computing devices. One or more of modules 816 and 826 in FIG. 8 may also represent all or portions of one or more special-purpose computers configured to perform one or more tasks.

Physical processors 812 and 822 generally represent any type or form of hardware-implemented processing unit capable of interpreting and/or executing computer-readable instructions. In one example, physical processors 812 and 822 may access and/or modify one or more of modules 816 and 826, respectively. Additionally or alternatively, physical processors 812 and 822 may execute one or more of modules 816 and 826 to facilitate adaptive streaming of multimedia content. Examples of physical processors 812 and 822 include, without limitation, microprocessors, microcontrollers, central processing units (CPUs), field-programmable gate arrays (FPGAs) that implement softcore processors, application-specific integrated circuits (ASICs), portions of one or more of the same, variations or combinations of one or more of the same, and/or any other suitable physical processor.

Memory 814 and 824 generally represent any type or form of volatile or non-volatile storage device or medium capable of storing data and/or computer-readable instructions. In one example, memory 814 and/or 824 may store, load, and/or maintain one or more of modules 816 and 826. Examples of memory 814 and/or 824 include, without limitation, random access memory (RAM), read only memory (ROM), flash memory, hard disk drives (HDDs), solid-state drives (SSDs), optical disk drives, caches, variations or combinations of one or more of the same, and/or any other suitable memory device or system.

FIG. 9 is a block diagram of exemplary components of content distribution infrastructure 810 according to certain embodiments. Distribution infrastructure 810 may include storage 910, services 920, and a network 930. Storage 910 generally represents any device, set of devices, and/or systems capable of storing content for delivery to end users. Storage 910 may include a central repository with devices capable of storing terabytes or petabytes of data and/or may include distributed storage systems (e.g., appliances that mirror or cache content at Internet interconnect locations to provide faster access to the mirrored content within certain regions). Storage 910 may also be configured in any other suitable manner.

As shown, storage 910 may store, among other items, content 912, user data 914, and/or log data 916. Content 912 may include television shows, movies, video games, user-generated content, and/or any other suitable type or form of content. User data 914 may include personally identifiable information (PII), payment information, preference settings, language and accessibility settings, and/or any other information associated with a particular user or content player. Log data 916 may include viewing history information, network throughput information, and/or any other metrics associated with a user’s connection to or interactions with distribution infrastructure 810.

Services 920 may include personalization services 922, transcoding services 924, and/or packaging services 926. Personalization services 922 may personalize recommendations, content streams, and/or other aspects of a user’s experience with distribution infrastructure 810. Encoding services, such as transcoding services 924, may compress media at different bitrates which may enable real-time switching between different encodings. Packaging services 926 may package encoded video before deploying it to a delivery network, such as network 930, for streaming.

Network 930 generally represents any medium or architecture capable of facilitating communication or data transfer. Network 930 may facilitate communication or data transfer via transport protocols using wireless and/or wired connections. Examples of network 930 include, without limitation, an intranet, a wide area network (WAN), a local area network (LAN), a personal area network (PAN), the Internet, power line communications (PLC), a cellular network (e.g., a global system for mobile communications (GSM) network), portions of one or more of the same, variations or combinations of one or more of the same, and/or any other suitable network. For example, as shown in FIG. 9, network 930 may include an Internet backbone 932, an internet service provider 934, and/or a local network 936.

FIG. 10 is a block diagram of an exemplary implementation of content player 820 of FIG. 8. Content player 820 generally represents any type or form of computing device capable of reading computer-executable instructions. Content player 820 may include, without limitation, laptops, tablets, desktops, servers, cellular phones, multimedia players, embedded systems, wearable devices (e.g., smart watches, smart glasses, etc.), smart vehicles, gaming consoles, internet-of-things (IoT) devices such as smart appliances, variations or combinations of one or more of the same, and/or any other suitable computing device.

As shown in FIG. 10, in addition to processor 822 and memory 824, content player 820 may include a communication infrastructure 1002 and a communication interface 1022 coupled to a network connection 1024. Content player 820 may also include a graphics interface 1026 coupled to a graphics device 1028, an audio interface 1030 coupled to an audio device 1032, an input interface 1034 coupled to an input device 1036, and a storage interface 1038 coupled to a storage device 1040.

Communication infrastructure 1002 generally represents any type or form of infrastructure capable of facilitating communication between one or more components of a computing device. Examples of communication infrastructure 1002 include, without limitation, any type or form of communication bus (e.g., a peripheral component interconnect (PCI) bus, PCI Express (PCIe) bus, a memory bus, a frontside bus, an integrated drive electronics (IDE) bus, a control or register bus, a host bus, etc.).

As noted, memory 824 generally represents any type or form of volatile or non-volatile storage device or medium capable of storing data and/or other computer-readable instructions. In some examples, memory 824 may store and/or load an operating system 1008 for execution by processor 822. In one example, operating system 1008 may include and/or represent software that manages computer hardware and software resources and/or provides common services to computer programs and/or applications on content player 820.

Operating system 1008 may perform various system management functions, such as managing hardware components (e.g., graphics interface 1026, audio interface 1030, input interface 1034, and/or storage interface 1038). Operating system 1008 may also process memory management models for playback application 1010. The modules of playback application 1010 may include, for example, a content buffer 1012, an audio decoder 1018, and a video decoder 1020.

Playback application 1010 may be configured to retrieve digital content via communication interface 1022 and play the digital content through graphics interface 1026. A video decoder 1020 may read units of video data from audio buffer 1014 and/or video buffer 1016 and may output the units of video data in a sequence of video frames corresponding in duration to the fixed span of playback time. Reading a unit of video data from video buffer 1016 may effectively de-queue the unit of video data from video buffer 1016. The sequence of video frames may then be rendered by graphics interface 1026 and transmitted to graphics device 1028 to be displayed to a user.

In situations where the bandwidth of distribution infrastructure 810 is limited and/or variable, playback application 1010 may download and buffer consecutive portions of video data and/or audio data from video encodings with different bit rates based on a variety of factors (e.g., scene complexity, audio complexity, network bandwidth, device capabilities, etc.). In some embodiments, video playback quality may be prioritized over audio playback quality. Audio playback and video playback quality may also be balanced with each other, and in some embodiments audio playback quality may be prioritized over video playback quality.

Content player 820 may also include a storage device 1040 coupled to communication infrastructure 1002 via a storage interface 1038. Storage device 1040 generally represent any type or form of storage device or medium capable of storing data and/or other computer-readable instructions. For example, storage device 1040 may be a magnetic disk drive, a solid-state drive, an optical disk drive, a flash drive, or the like. Storage interface 1038 generally represents any type or form of interface or device for transferring data between storage device 1040 and other components of content player 820.

Many other devices or subsystems may be included in or connected to content player 820. Conversely, one or more of the components and devices illustrated in FIG. 10 need not be present to practice the embodiments described and/or illustrated herein. The devices and subsystems referenced above may also be interconnected in different ways from that shown in FIG. 10. Content player 820 may also employ any number of software, firmware, and/or hardware configurations.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive an application request to be transformed, transform the application request, output a result of the transformation to prioritize a type of request, use the result of the transformation to perform load-shedding, and store the result of the transformation to execute application requests for client devices. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
detecting, by a computing device of a server group, a set of in-flight requests for an application;
determining, by the computing device, that the set of in-flight requests exceeds a predetermined threshold for the server group;
identifying, by the computing device, a first type of request and a second type of request in the set of in-flight requests;
prioritizing, by performing a load-shedding process for the server group, the first type of request over the second type of request; and
executing a remaining set of requests of the set of in-flight requests for the application.

2. The method of claim 1, wherein detecting the set of in-flight requests comprises:
receiving network traffic from at least one client device; and
detecting at least one request for the application from the client device.

3. The method of claim 1, wherein determining that the set of in-flight requests exceeds the predetermined threshold comprises at least one of:
determining a total number of requests in the set of in-flight requests exceeds a threshold number of requests for the server group; or
determining a system latency exceeds a threshold latency for the server group.

4. The method of claim 3, wherein the system latency comprises at least one of:
a latency of at least one request in the set of in-flight requests; or
a latency in a downstream service of the server group.

5. The method of claim 1, wherein the first type of request comprises a user-initiated request categorized by an application programming interface of the application.

6. The method of claim 1, wherein the second type of request comprises a prefetch request initiated by a client device for the application.

7. The method of claim 1, wherein prioritizing the first type of request over the second type of request comprises:
executing all requests of the first type of request prior to executing any request of the second type of request; and
dropping a request of the second type of request based on a timing of the request.

8. The method of claim 1, wherein prioritizing the first type of request over the second type of request comprises dynamically repurposing a reserved capacity of the server group for the first type of request.

9. The method of claim 1, further comprising isolating a request of the set of in-flight requests based on a type of the request.

10. The method of claim 1, further comprising:
updating the set of in-flight requests for the application;
determining that the updated set of in-flight requests does not exceed the predetermined threshold for the server group; and
executing the updated set of in-flight requests.

11. The method of claim 10, wherein executing the updated set of in-flight requests comprises suspending the load-shedding process for the server group.

12. A system comprising:
a detection module, stored in memory, that detects, by a computing device of a server group, a set of in-flight requests for an application;
a determination module, stored in memory, that determines, by the computing device, that the set of in-flight requests exceeds a predetermined threshold for the server group;
an identification module, stored in memory, that identifies, by the computing device, a first type of request and a second type of request in the set of in-flight requests;
a prioritization module, stored in memory, that prioritizes, by performing a load-shedding process for the server group, the first type of request over the second type of request;
an execution module, stored in memory, that executes a remaining set of requests of the set of in-flight requests for the application; and
at least one processor that executes the detection module, the determination module, the identification module, the prioritization module, and the execution module.

13. The system of claim 12, wherein the server group comprises a distributed system with a set of servers that services application requests for a set of client devices.

14. The system of claim 13, wherein the determination module determines that the set of in-flight requests exceeds the predetermined threshold for the server group by:
detecting a total current capacity of the set of servers; and
determining that an expected capacity to execute the set of in-flight requests exceeds the total current capacity of the set of servers.

15. The system of claim 13, wherein the detection module detects the set of in-flight requests for the application by receiving, at an application programming interface of the server group, at least one application request from an application programming interface of a client device in the set of client devices.

16. The system of claim 15, wherein the prioritization module comprises a concurrency limiter that determines a concurrency limit for executing application requests by the application programming interface of the server group.

17. The system of claim 16, wherein the prioritization module prioritizes the first type of request over the second type of request in response to the application programming interface of the server group reaching the concurrency limit.

18. The system of claim 12, wherein the load-shedding process comprises a process to:
select at least one request of the second type of request; and
drop the request.

19. The system of claim 12, wherein:
the identification module further identifies a third type of request and a fourth type of request in the set of in-flight requests; and
the prioritization module further prioritizes, by performing the load-shedding process for the server group, the third type of request over the fourth type of request.

20. A computer-readable medium comprising one or more computer-executable instructions that, when executed by at least one processor of a computing device, cause the computing device to:
detect, by the computing device of a server group, a set of in-flight requests for an application;
determine, by the computing device, that the set of in-flight requests exceeds a predetermined threshold for the server group;
identify, by the computing device, a first type of request and a second type of request in the set of in-flight requests;
prioritize, by performing a load-shedding process for the server group, the first type of request over the second type of request; and
execute a remaining set of requests of the set of in-flight requests for the application.
